(19) United States
(12) Patent Application Publication
(10) Pub. No.: US 2025/0193928 A1
(43) Pub. Date: Jun. 12, 2025

(54) Directional Listen Before Talk for sub-THz Access Points

(71) Applicant: Apple Inc., Cupertino, CA (US)

(72) Inventors: Jan K. ELLENBECK, Gruenwald (DE); Biljana BADIC, Munich (DE); Christian DREWES, Germering (DE); Mikhail WILHELM, Munich (DE); Norman GORIS, Dortmund (DE); Stefan MEYER, Hoechstadt (DE)

(21) Appl. No.: 18/394,281

(22) Filed: Dec. 22, 2023

Related U.S. Application Data
(60) Provisional application No. 63/607,847, filed on Dec. 8, 2023.

(51) Int. Cl. H04W 74/0816; H04B 17/336; H04W 16/28; H04W 24/08

(52) U.S. Cl. CPC H04W 74/0816; H04B 17/336; H04W 16/28; H04W 24/08

(57) ABSTRACT

A processor configured to monitor, using multiple antennas, for interference signals originating from each of multiple directions and select a first direction of the multiple directions to perform a directional listen-before-talk (LBT) procedure, wherein the first direction is selected based on the interference signals originating from each of the multiple directions.

### PRIORITY/INCORPORATION BY REFERENCE

This application claims priority to U.S. Provisional Application Ser. No. 63/607,847 entitled “Spectrum Access with Directed sub-THz and Omni-Directional Anchor RAT” filed on Dec. 8, 2023, the entirety of which is incorporated herein by reference.

### BACKGROUND

The sub-THz frequency range is a promising candidate for 6G wireless networks mainly due to the huge bandwidth enabling transmission of hundreds of Gigabits per second (Gbps). Short communication ranges and no incumbent radio services suggest that large parts of the spectrum will be unlicensed. Similar to current unlicensed bands at lower frequencies, spectrum sharing mechanisms such as Listen-Before-Talk (LBT) using Clear Channel Assessment (CCA) may be required for the sub-THz frequency range.

To offset the large pathloss due to the short wavelength, systems may have to use beamforming on both sides of the link. Transmissions and also the interference situation will be highly directive, e.g., with strong interference from some directions and low interference from other directions. Thus, LBT may have to be performed directionally where the CCA result will depend on the direction of the communication peer relative to directional interference sources.

It has been identified that there is a need to provide improvements in directional LBT methods because current methods may result in wasted resources when there is an LBT failure in a specific direction.

### SUMMARY

Some example embodiments are related to an apparatus including processing circuitry configured to monitor, using multiple antennas, for interference signals originating from each of multiple directions and select a first direction of the multiple directions to perform a directional listen-before-talk (LBT) procedure, wherein the first direction is selected based on the interference signals originating from each of the multiple directions.

Other example embodiments are related to an apparatus including processing circuitry configured to monitor, using analog beamforming, for interference signals originating from a first direction, determine, based on the monitoring in the first direction, whether interference signals are originating from a second direction and perform a directional listen-before-talk (LBT) procedure comprising a directional clear channel access (CCA) procedure in the second direction based on whether there are interference signals originating from the second direction.

Still further example embodiments are related to an apparatus including processing circuitry configured to initiate a first directional listen-before-talk (LBT) procedure comprising a directional clear channel access (CCA) procedure in a first direction and during the first LBT procedure, initiate a second LBT procedure comprising a directional CCA procedure in a second direction.

### BRIEF DESCRIPTION OF THE DRAWINGS

FIG. 1 shows an example network arrangement according to various example embodiments.

FIG. 2 shows an example user equipment (UE) according to various example embodiments.

FIG. 3 shows an example base station according to various example embodiments.

FIG. 4 shows an example of a successful LBT procedure including a directional CCA according to various example embodiments.

FIG. 5 shows an example of a failed LBT procedure including a directional CCA according to various example embodiments.

FIG. 6 shows an example of an intelligent LBT using spatial awareness according to various example embodiments.

FIG. 7 shows a schematic view of a digital beamforming architecture and a hybrid beamforming architecture according to various example embodiments.

FIG. 8 shows a first example of an LBT procedure including a directional CCA based on a direction of arrival (DoA) estimation according to various example embodiments.

FIG. 9 shows a second example of an LBT procedure including a directional CCA based on a DoA estimation according to various example embodiments.

FIG. 10 shows an example of an interleaved LBT procedure according to various example embodiments.

### DETAILED DESCRIPTION

The example embodiments may be further understood with reference to the following description and the related appended drawings, wherein like elements are provided with the same reference numerals. The example embodiments relate to an intelligent selection of a listen-before-talk (LBT) direction including a directional Clear Channel Assessment (CCA) procedure.

The example embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate type of electronic component.

The example embodiments are also described with regard to a fifth generation (5G) New Radio (NR) network and a next generation node B (gNB). However, reference to a 5G NR network and a gNB is merely provided for illustrative purposes. The example embodiments may be utilized with any appropriate type of network (e.g., 5G-Advanced network, 6G network, etc.) and base station.

As will be described in greater detail below, the example embodiments of an intelligent selection of an LBT direction are described as being performed by an access point (AP). This is based on the facts that APs typically have multiple users to schedule and can thus exploit multi-user diversity, have a permanent power supply that allows AP to monitor the interference environment without regard to energy usage and may be more complex and powerful than other types of user devices such as user equipment (UE) and therefore are more likely to have digital or hybrid beamforming and signal processing capabilities.

However, the example embodiments are not limited to being implemented in APs. As described above, it is expected that beamforming may be used on both sides of the link in sub-THz systems, meaning that both devices on a link may perform directional CCA/LBT procedures. Thus, any device, including UEs that may have digital or hybrid beamforming capability may implement the example embodiments. In some examples, devices that are operating in a mesh network and have multiple peers to communicate with may use the example embodiments. In other examples, for device (e.g., UE) initiated uplink transmissions, the idle listening phase of the CCA procedure may be shortened if the device can monitor the interference situation even before it has new data to send in the uplink. In some example embodiments, even devices that are only capable of analog beamforming may implement the example embodiments as described in further detail below.

In some example embodiments, the device (e.g., AP, base station, UE, etc.) uses beamforming (e.g., digital or hybrid beamforming) to monitor for interference in multiple directions (e.g., omni-directional direction of arrival (DoA) estimation). Using this omni-directional interference information, the device may then select the directional LBT that has the highest likelihood of success.

In other example embodiments, analog beamforming may be used to monitor for interference in a single direction and this information may be used to determine operations of an LBT procedure that should be performed when the LBT procedure is initiated for a different direction.

In still further example embodiments, LBT procedures may be interleaved to save time when a CCA failure occurs for one of the LBT procedures. These and other example embodiments are described in greater detail below.

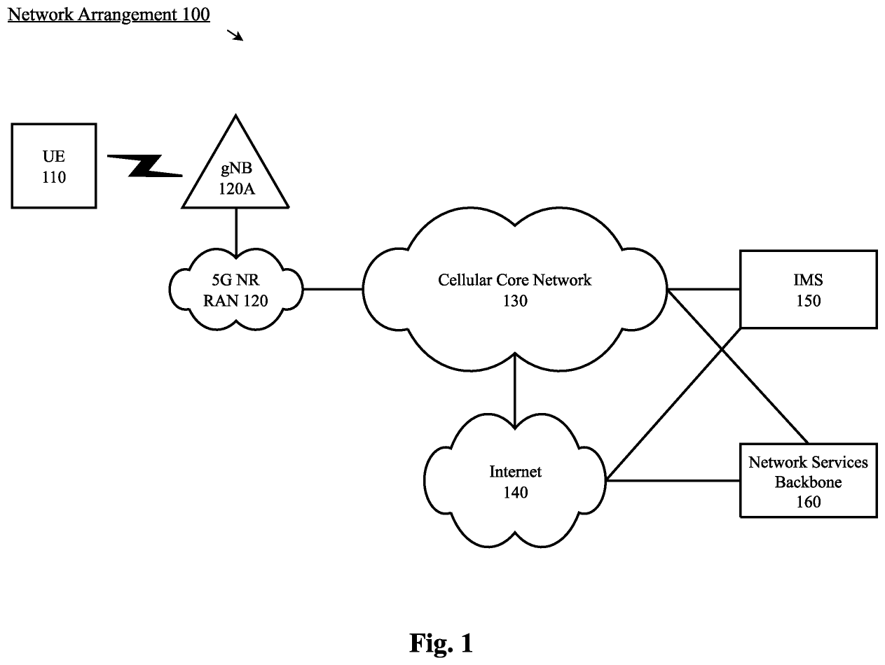

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, phablets, embedded devices, wearables, Internet of Things (IoT) devices, etc. An actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., sixth generation (6G) RAN, 5G cloud RAN, a next generation RAN (NG-RAN), a long-term evolution (LTE) RAN, a legacy cellular network, a wireless local area network (WLAN), etc.) and the UE 110 may also communicate with networks over a wired connection. With regard to the example embodiments, the UE 110 may establish a connection with the 5G NR RAN 120. Therefore, the UE 110 may have at least a 5G NR chipset to communicate with the 5G NR RAN 120.

The 5G NR RAN 120 may be a portion of a cellular network that may be deployed by a network carrier (e.g., Verizon, AT&T, T-Mobile, etc.). The 5G NR RAN 120 may include base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. As used herein, the term “base station,” “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can comprise ground stations (e.g., terrestrial access points) or satellite stations providing coverage within a geographic area (e.g., a cell). In fact, in some embodiments, a UE, such as UE 110 described herein, may function as an access point.

Any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer to an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

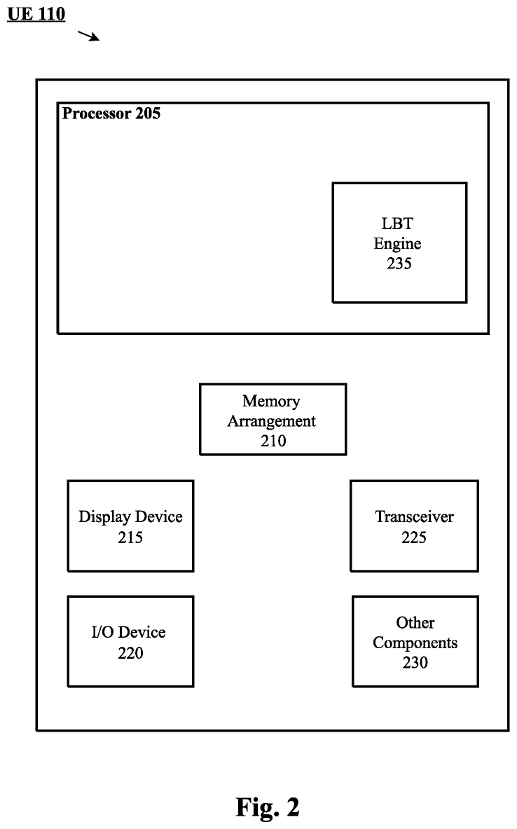

FIG. 2 shows an example UE 110 according to various example embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include an LBT engine 235. The LBT engine 235 may perform various operations related to an LBT procedure including CCA operations. To provide some general examples, the LBT engine 235 may perform operations such as, but not limited to, monitoring an interference environment of the UE, selecting directional LBT operations based on the interference environment and performing LBT operations. Each of these example operations will be described in greater detail below.

The above referenced engine being an application (e.g., a program) executed by the processor 205 is merely provided for illustrative purposes. The functionality associated with the engine may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

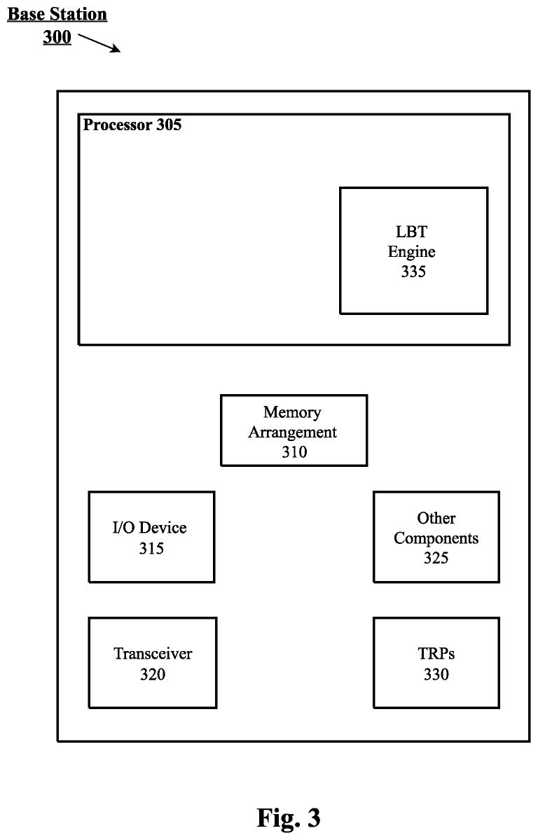

FIG. 3 shows an example base station 300 according to various example embodiments. The base station 300 may represent the gNB 120A or any other type of access node through which the UE 110 may establish a connection and manage network operations. As used herein, the term “base station” may also refer to an “access node,” “access point,” or the like and may describe equipment that provides the radio baseband functions for data and/or voice connectivity between a network and one or more users. These base stations and access nodes can be referred to as BS, gNBs, RN nodes, eNBs, NodeBs, RSUs, TRxPs or TRPs, and so forth, and can comprise ground stations (e.g., terrestrial access points) or satellite stations providing coverage within a geographic area (e.g., a cell).

The base station 300 may include a processor 305, a memory arrangement 310, an input/output (I/O) device 315, a transceiver 320, multiple TRPs 330 and other components 325. The other components 325 may include, for example, an audio input device, an audio output device, a battery, a data acquisition device, ports to electrically connect the base station 300 to other electronic devices and/or power sources, TxRUs, transceiver chains, antenna elements, antenna panels, etc.

The processor 305 may be configured to execute a plurality of engines for the base station 300. For example, the engines may include an LBT engine 335. The LBT engine 335 may perform various operations related to an LBT procedure including CCA operations. To provide some general examples, the LBT engine 335 may perform operations such as, but not limited to, monitoring an interference environment of the UE, selecting directional CCA operations based on the interference environment and performing CCA operations. Each of these example operations will be described in greater detail below.

The above noted engine being applications (e.g., a program) executed by the processor 305 is only an example. The functionality associated with the engine may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The example embodiments may be implemented in any of these or other configurations of a base station.

The memory 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UEs in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

As previously mentioned, the sub-THz frequency range is a promising candidate for 6G wireless networks mainly due to the huge bandwidth enabling transmission of hundreds of Gbps. In the case of unlicensed spectrum, which is expected for at least a portion of the sub-THz frequency range, beam handling and UE access may be complicated due to directional (i.e., beamformed) clear channel assessments (beamformed listen-before-talk (LBT)).

A directional LBT mechanism may be applied such that before starting a new beamformed transmission with a transmission (Tx) beamformer w, a UE may sense the power received using the same beamformer w applied for reception (Rx). The received power, including beamforming gain from w, must be below a certain threshold for the channel to be considered clear for the Tx.

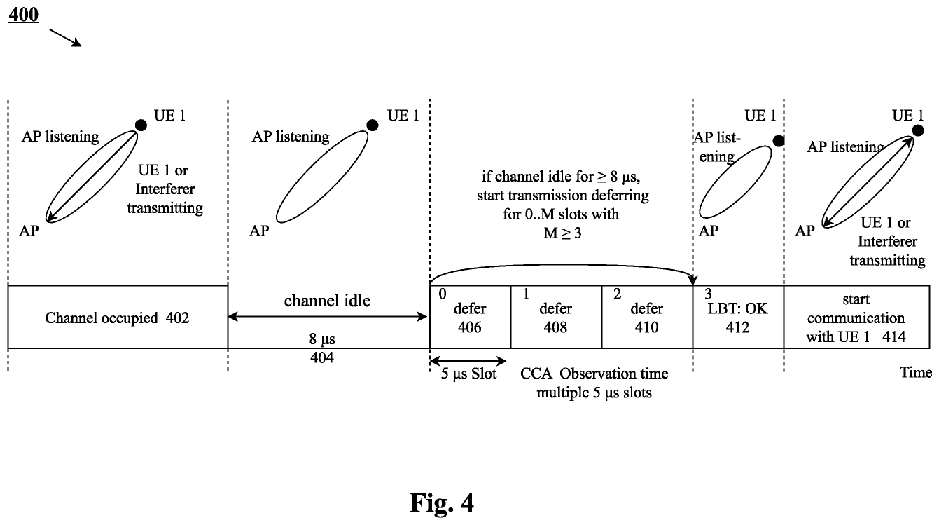

FIG. 4 shows an example of a successful LBT procedure 400 including a directional CCA according to various example embodiments. It should be understood that the LBT procedure 400 is only an example of one type of LBT procedure that may be used for spectrum access. The example embodiments may be applied to the LBT procedure 400 but may also be applied to other types of LBT procedures.

During the time 402, the channel is occupied as the UE 1 or an interferer is transmitting. At 404, the access point (AP) may determine that the channel is idle based on a CCA check using an “energy detect.” In this example, the threshold may be −80 dBm+10*log₁₀ (BW in MHz). This threshold is only an example and other thresholds may be used. The threshold may be evaluated over the whole slot duration (8 μs idle phase and 5 μs CCA slot) so that a very short and high interference burst (e.g., from beam sweep by neighbor cell) does not push the time weighted average energy detection above the threshold value.

When the CCA determines the channel has been idle for 8 μs, random transmission deferring occurs for a random (0 to 3+) number of 5 μs slots 406-412. In this example, the directional CCA is performed in the slot 412 and it is determined that the LBT is successful such that at time 414 the UE 1 and the AP may perform communications.

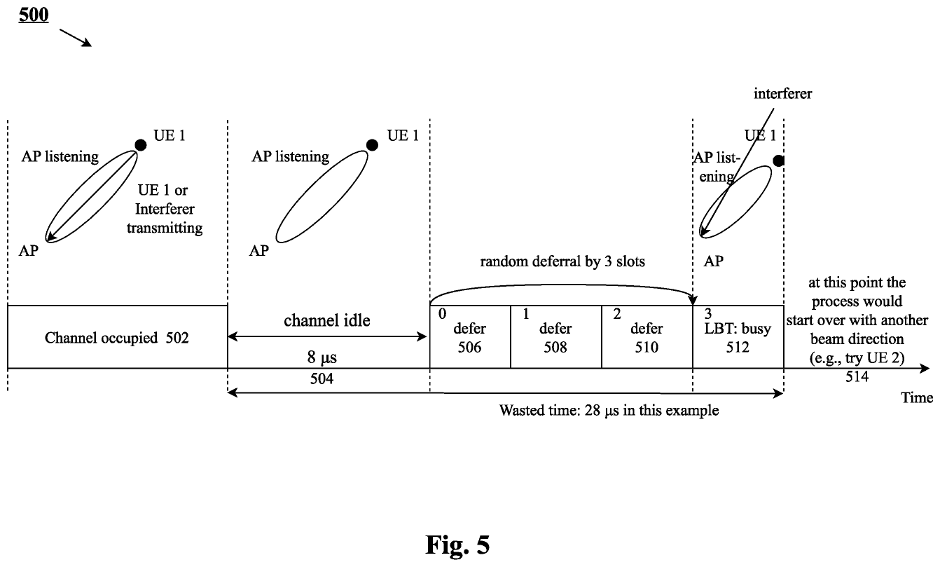

FIG. 5 shows an example of a failed LBT procedure 500 including a directional CCA according to various example embodiments. Similar to the example LBT procedure 400 described above, it should be understood that the LBT procedure 500 is only an example of one type of LBT procedure that may be used for spectrum access.

During the time 502, the channel is occupied as the UE 1 or an interferer is transmitting. At 504, the AP may determine that the channel is idle based on a CCA check similar to that described above for the LBT procedure 400.

When the AP determines the channel has been idle for 8 μs, random transmission deferring occurs for a random (0 to 3+) number of 5 μs slots 506-512. In this example, the directional CCA is performed in the slot 512 but it is not successful. Thus, at 514, the LBT procedure starts over with another beam direction, e.g., in the direction of a UE 2.

From these examples, it can be seen that the CCA check consumes a significant amount of time even if successful, e.g., 13 μs if the first CCA slot is used, 18 μs if the second CCA slot is used, 23 μs if the third CCA slot is used and 28 μs if the fourth CCA slot is used. In addition, the use of 4 CCA slots is only an example and the time may be greater if additional deferred LBT slots are used. If the CCA fails as in the example of FIG. 5, the entire 28 μs is wasted.

In the example embodiments, it may be considered that the device performing the LBT procedure (e.g., the AP) may have multiple TRx chains and may also perform digital beamforming or hybrid beamforming. As will be described in greater detail below, this may allow the AP to perform a more intelligent LBT with spatial awareness.

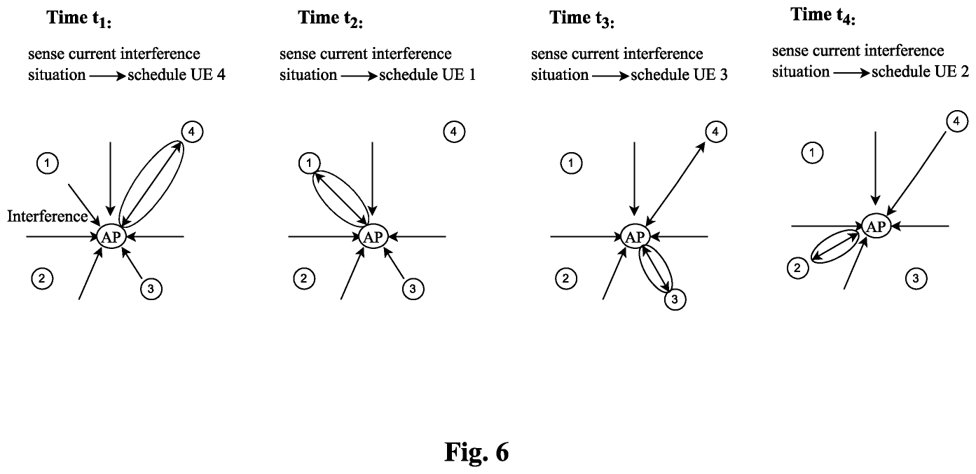

FIG. 6 shows an example of an intelligent LBT using spatial awareness according to various example embodiments. In the example of FIG. 6, it may be considered that the AP performs communications with UEs in four (4) spatial directions numbered 1-4 in FIG. 6. In conventional cases, the AP will perform the directional LBT in a predefined order, e.g., 1, 2, 3, 4. However, according to the example embodiments, the AP may use spatial awareness to change the order of the directional LBT to select a direction that is likely to result in a successful LBT. Example manners for the AP to determine the spatial awareness to be used to select the direction for the LBT to be performed will be described in greater detail below. The description of FIG. 6 is provided to show how the spatial awareness may be used.

In FIG. 6, at a first time (t₁), the AP may have a spatial awareness that indicates there is likely interference from directions 1-3. Thus, the AP may determine to perform the directional LBT for the direction 4 because that is the direction most likely to result in a successful LBT.

Similarly, at a second time (t₂), the AP may have a spatial awareness that indicates there is likely interference from directions 2-3. Thus, the AP may determine to perform the directional LBT for the direction 1 because that is the direction most likely to result in a successful LBT. In this example, the AP may determine that there is also little interference from direction 4 but the AP may select the direction 1 because the direction 4 was previously selected. In other examples, the direction 1 may be selected over direction 4 because while both directions indicate a likely success of the directional LBT, it is more likely that the direction 1 LBT will be successful. For example, if the AP determines that there is a high likelihood that the LBT will be successful in two different directions, the AP may select the direction that has a higher likelihood. This may result in higher throughput because the direction that has the highest likelihood of success may have the best channel for transmissions as opposed to another channel that is successful but may only be marginally below the interference threshold. Other metrics may also be used to select the preferred direction, e.g., data priority, UE priority, past performance (proportional-fair), etc.

Continuing with the example of FIG. 6, at a third time (t₃), the AP may have a spatial awareness that indicates there is likely interference from directions 2 and 4. Thus, the AP may determine to perform the directional LBT for the direction 3 because that is the direction most likely to result in a successful LBT.

Finally, at a fourth time (t₄), the AP may have a spatial awareness that indicates there is likely interference from directions 3 and 4. Thus, the AP may determine to perform the directional LBT for the direction 2 because that is the direction most likely to result in a successful LBT.

Thus, in this example, instead of blindly performing the directional LBT in a predetermined order, the AP uses spatial awareness to schedule the directional LBT in a manner that is most likely to result in successful LBT procedures. In a best case scenario, using the spatial awareness may result in a single successful LBT procedure in each direction.

As described above, in these examples, it may be considered that the AP may have multiple TRx chains that allow the AP to perform digital or hybrid beamforming. The digital or hybrid beamforming means that the AP may detect interference in multiple directions as opposed to a single direction as in analog beamforming scenarios using a single TRx chain. In the example embodiments it is described that the AP is the device that has the digital or hybrid beamforming capabilities and therefore may implement the example embodiments. However, it should be understood that it is possible that other devices such as UEs may be equipped with digital or hybrid beamforming capabilities and in such cases, these other devices may also implement the example embodiments.

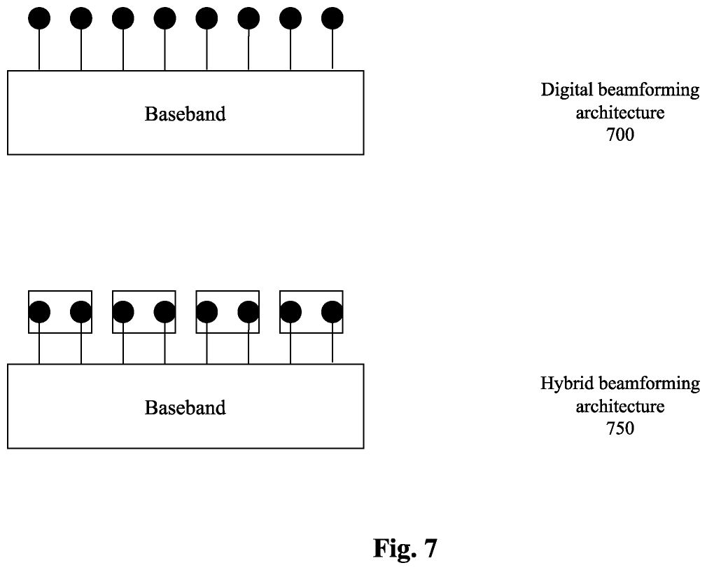

FIG. 7 shows a schematic view of a digital beamforming architecture 700 and a hybrid beamforming architecture 750 according to various example embodiments. In the example of FIG. 7, the digital beamforming architecture 700 is shown as including eight (8) antenna elements that each may have its own TRx chain for processing received signals by the baseband processor. This would allow the AP to simultaneously determine spatial awareness (e.g., interference) in 8 directions. As described above, this spatial awareness may be used to select the directional LBT that is most likely to succeed.

The hybrid beamforming architecture 750 is shown as including eight (8) antenna elements and four (4) TRx chains. Thus, in this example, two antenna elements may feed signals to a TRx chain for processing by the baseband processor. This would allow the AP to simultaneously determine spatial awareness (e.g., interference) in 4 directions. As described above, this spatial awareness may be used to select the directional LBT that is most likely to succeed.

The example of 8 direction or 4 direction spatial awareness is only an example. Implementations of the digital beamforming architecture or hybrid beamforming architecture may result in a different number of spatial awareness directions depending on the number of antenna elements, TRx chains, etc. In addition, the number and direction of the spatial awareness in hybrid beamforming architectures may also depend on how the signals from the various antenna elements are combined into different TRx chains.

As described above, the AP may use the spatial awareness to select the directional LBT with the highest likelihood of success. The spatial awareness for each of the directions may be determined using direction of arrival (DoA) estimation. Those skilled in the art will understand that there are various manners of performing DoA estimations and the example embodiments may implement any of these manners of performing DoA estimations. To provide some examples, DoA estimates are typically performed using either spectral estimation techniques (beam scan) or subspace techniques. The beam scan techniques may include a delay and sum method or a Minimum Variance Distortionless Response (MVDR) method. The subspace techniques may include Multiple Signal Classification (MUSIC) or an Estimation of Signal Parameters via Rotational Invariance Techniques (ESPRIT).

Again, there is no requirement that a specific type of DoA estimation is used to determine the spatial awareness. The DoA estimate for the directional CCA threshold decision does not need to be extremely accurate. Rather, an indication of the relative interference in each of the measured directions is sufficient for the selection of the directional LBT. In some example embodiments, a threshold for directional LBT interference may be set to 34 dB above noise. However, this is only an example and other thresholds may be used.

As stated above, using spatial processing with multiple antennas and Rx chains allows the AP to understand the interference in multiple directions and this information may be used to select the LBT direction that has the highest likelihood of success (e.g., using DoA estimation, digital beamforming, etc.). FIG. 6 showed some examples of interference determined using multi-directional DoA sensing. However, there may also be other interference scenarios that the multi-directional DoA sensing indicates to the AP. For example, the multi-directional DoA sensing may indicate scenarios where the link between the AP and a UE experiences high directional interference that does not coincide with the AP-UE beam direction. For example, in single direction monitoring, there may be a scenario where the AP does not identify an interferer because the AP is not interfered with but the UE is interfered, e.g., the interferer is behind the AP such that the interferer, the AP and UE form a substantially straight line. In this scenario, the UE may experience a high degree of interference but the single direction monitoring by the AP will not “see” the interferer because it is behind the AP. The multi-directional DoA sensing will “see” this type of interferer.

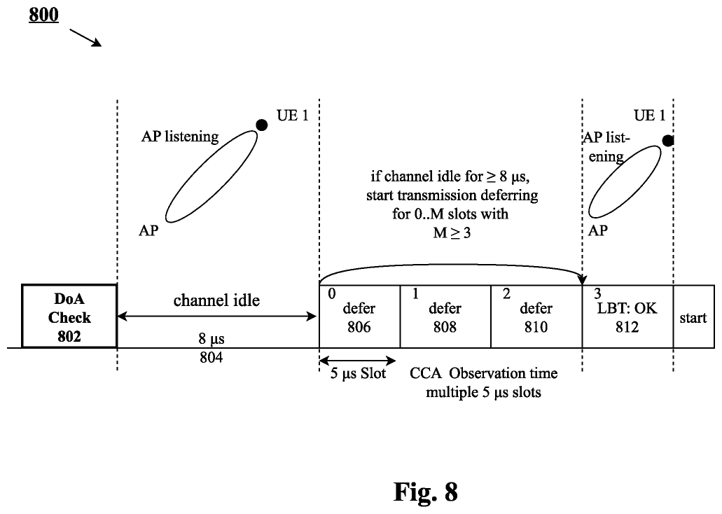

FIG. 8 shows a first example of an LBT procedure 800 including a directional CCA based on a DoA estimation according to various example embodiments. The LBT procedure 800 is similar to the LBT procedures 400 and 500 described above except that a DoA check 802 is performed by the AP to determine which directional LBT should be performed.

In the example of FIG. 8, the DoA check 802 is performed by the AP before the channel idle phase 804. As described above, the DoA check may be performed by the AP based on signal processing techniques related to the digital beamforming architecture or hybrid beamforming architecture to measure the interference in multiple directions. In the example of FIG. 8, the DoA check 802 uses an additional time slot, e.g., before the idle phase 804. However, this time slot may be based on the interference threshold, e.g., a higher threshold results in a shorter time slot. In addition, because the AP is not performing any concurrent Tx/Rx activity during this DoA check 802 time slot, the measurements may have a very high fidelity.

Thus, after the DoA check 802, the AP may determine the directional CCA that has the highest likelihood of success. For example, referring back to FIG. 6, the scenario associated with t₁ may be determined, e.g., the directional CCA in direction 4 has the highest likelihood of success. Thus, the remaining operations of the LBT procedure 800 may be for a directional CCA in direction 4. This may include the idle phase 804, the deferral of CCA slots 806-810 and the CCA operation in slot 812. Moreover, because the DoA check 802 is performed prior to the idle phase 804, the idle phase 804 may use analog beamforming because the direction is selected and that is the only direction that will be monitored for the remaining operations of the LBT procedure 800.

Thus, the LBT procedure 800 uses the interference knowledge that is determined from the DoA check 802 to select the directional CCA that has the highest likelihood of success.

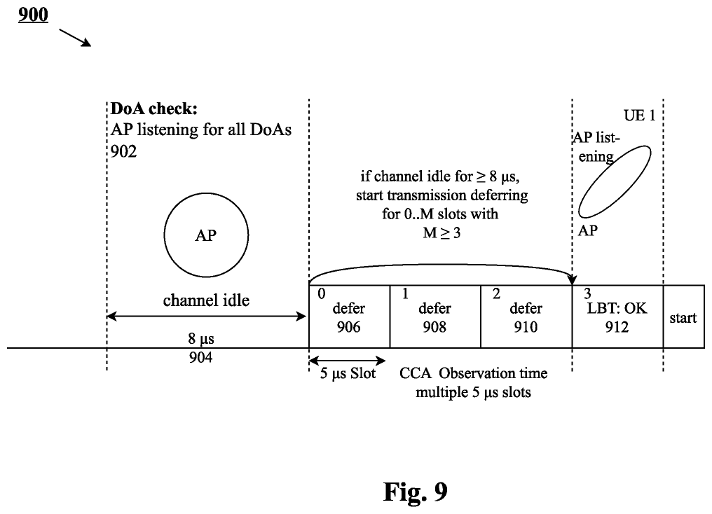

FIG. 9 shows a second example of an LBT procedure 900 including a directional CCA based on a DoA estimation according to various example embodiments. The LBT procedure 900 is similar to the LBT procedures 400 and 500 described above except that a DoA check 902 is performed by the AP to determine which directional CCA should be performed.

In the example of FIG. 9, the DoA check 902 is performed by the AP during the channel idle phase 904. As described above, the DoA check may be performed by the AP based on signal processing techniques related to the digital beamforming architecture or hybrid beamforming architecture to measure the interference in multiple directions. In the example of FIG. 9, the DoA check 902 is performed at the same time as the idle phase 904 and therefore no extra time slot used for the DoA check 902. The AP may perform the DoA check 902 during the entirety of the 8 μs idle phase 904, e.g., the AP may monitor all directions for the entire idle phase 904 duration of 8 μs. In this example embodiment, the DoA check 902 may provide the AP with a timely decision regarding interference because the determination will be made at the end of the idle phase 904 and there may be a smaller likelihood of a new interferer arising before the CCA slots 906-912.

Thus, the LBT procedure 900 uses the interference knowledge that is determined from the DoA check 902 to select the directional CCA that has the highest likelihood of success.

In some example embodiments, instead of defining a specific period for the DoA check (e.g., DoA check 802, DoA check 902), the AP may perform a continuous DoA estimation to always have a complete picture of surrounding interference sources. This continuous DoA estimation may be performed in parallel during each Rx operation or during gaps. The use of a continuous DoA estimation may provide a comprehensive interference picture, e.g., which directions are most/least interfered, and may also allow for the preemption of an ongoing transmission if an often-blocked link becomes available. For example, referring back to FIG. 6, it may be considered that the direction 2 LBT has a high failure rate (e.g., as indicated by a failed number of CCAs above a predetermined threshold in a defined time period, a large amount of data in a buffer, etc.) and the AP understands that this issue is arising because of interferers in the direction 2. When the AP is performing continuous DoA estimation and determines that there is no interference or a low level of interference in direction 2, the AP may preempt other operations (e.g., such as an ongoing LBT procedure in another direction, an ongoing Tx/Rx in another direction, etc.) and initiate the LBT procedure in the direction 2 when interference is low.

The continuous DoA estimation may also allow for the skipping of the idle phase, e.g., when new downlink data for a link arrives at the AP. For example, because the AP has continuous spatial awareness, the AP may not need to start an idle observation period because the AP already knows if the desired link direction was idle long enough. If direction was idle, the transmission may directly start with CCA deferral period.

In the above examples, it was described that the example embodiments may be implemented when the AP included digital or hybrid beamforming capabilities. However, in some example embodiments, it may also be possible to implement the example embodiments using analog beamforming in a desired direction. For example, when analog beamforming is used, the AP may still determine power from other directions but with much less gain, e.g., with 20 dB beamforming gain in the desired direction, power from other directions may be attenuated by 20 dB compared to the desired direction. However, since the CCA energy threshold (e.g., 34 dB over thermal noise) is quite high, a potentially blocking signal may still be detectable if it is attenuated by 20 dB as in the example above.

In these example embodiments using the analog beamforming, this detection may lack spatial resolution such that it is not clear from which direction the detected interference is arriving. However, when beamforming in a certain direction and the only interference detected is low, e.g., 5 dB over the thermal noise level, then beamforming in any other direction may not reveal a blocking signal using the above example thresholds of 34 dB over thermal noise if the beamforming gain is only 20 dB. In such cases, if the interference check has not detected any interference above a reduced threshold (e.g., 34 dB minus 20 dB BF gain), the AP may safely skip the 8 μs idle phase and directly perform the CCA deferral. On the other hand, if the interference power above the reduced threshold is detected, the device does not know if it would actually conflict with a new beamforming direction and therefore the AP may perform a normal LBT procedure (e.g., perform idle phase monitoring and CCA with the desired analog beam).

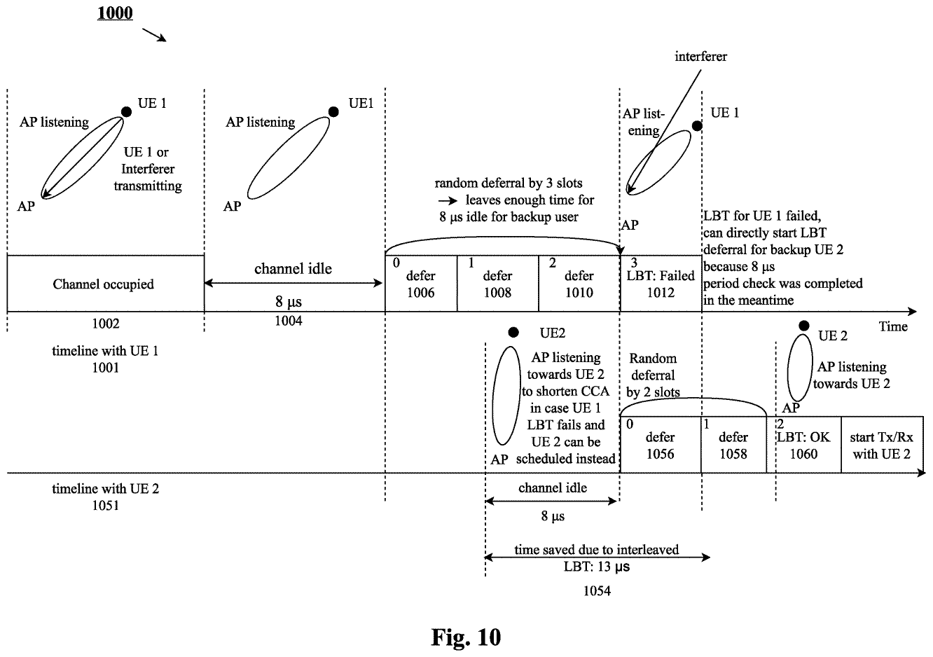

FIG. 10 shows an example of an interleaved LBT procedure 1000 according to various example embodiments. In this example, there are two CCA procedures illustrated, a first LBT procedure 1001 associated with a UE 1 having a first timeline and a second LBT procedure 1051 associated with a UE 2 having a second timeline. In the example of FIG. 10, the random deferral period of the first CCA procedure 1001 (e.g., CCA slots 1006-1012) may be used to prepare a backup transmission, e.g., start the second LBT procedure 1051 if the first LBT procedure is not successful.

The first LBT procedure 1001 is similar to the LBT procedures 400 and 500 described above and therefore will not be described in detail. The first LBT procedure 1001 includes the time 1002 when the channel is occupied, the channel idle phase 1004 and the CCA slots 1006-1012 including the random deferral.

The second LBT procedure 1051 is also similar to the LBT procedures 400 and 500 described above and therefore will not be described in detail. The second LBT procedure 1051 includes the channel idle phase 1054 and the CCA slots 1056-1060 including the random deferral. The second LBT procedure 1051 includes a different number of random deferral, e.g., 2 slots rather than 3 slots in the other examples, but is otherwise similar.

In these example embodiments, if the random deferral period of the first LBT procedure 1001 is long enough, the second LBT procedure 1051 may start during the first LBT procedure 1001. As shown in FIG. 10, the idle phase 1054 of the second LBT procedure 1051 is started during the deferral period of the first LBT procedure 1001. Thus, while the first LBT procedure 1001 is being performed some operations of the second LBT procedure 1051 may be performed.

In the example of FIG. 10, it is considered that the first LBT procedure 1001 fails as shown in CCA slot 1012. However, because the second LBT procedure 1051 has already been started, in this example, 13 μs of time for the second LBT procedure 1051 is saved (e.g., 8 μs of idle phase+5 μs of one CCA slot) because the second LBT procedure 1051 was started during the deferral period of the first LBT procedure 1001 rather than when the first LBT procedure 1001 failed, e.g., after the CCA slot 1012. It should be understood that the above is only an example and that differing amounts of time may be saved depending on when the second LBT procedure 1051 is started during the deferral period of the first LBT procedure 1001. For example, if the deferral slot 1056 was shifted to the right in FIG. 10, e.g., started after the slot 1012 of the first LBT procedure 1001, the amount of time that is saved would be less. In another example, if the deferral slot 1056 (and the channel idle 1054) was shifted to the left in FIG. 10, the amount of time that is saved would be more. The example embodiments may be implemented using any of these examples.

If the first LBT procedure 1001 is successful, the second LBT procedure 1051 may be aborted. In addition, the interleaving of LBT procedures may be performed separately from the examples of the DoA checks described above or may be combined with the DoA checks.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments described above may be embodied as a program containing lines of code stored on a non-transitory computer readable storage medium that, when compiled, may be executed on a processor or microprocessor.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. An apparatus comprising processing circuitry configured to:
monitor, using multiple antennas, for interference signals originating from each of multiple directions; and
select a first direction of the multiple directions to perform a directional listen-before-talk (LBT) procedure, wherein the first direction is selected based on the interference signals originating from each of the multiple directions.

2. The apparatus of claim 1, wherein the monitoring for the interference signals originating from each of the multiple directions comprises processing signals by multiple reception chains, wherein each reception chain is dedicated to one of the multiple antennas.

3. The apparatus of claim 1, wherein the monitoring for the interference signals originating from each of the multiple directions comprises processing signals by multiple reception chains, wherein each reception chain is configured to receive signals from two or more of the multiple antennas.

4. The apparatus of claim 1, wherein the processing circuitry is further configured to:
determine a strength of each of the interference signals using a direction of arrival (DoA) estimation.

5. The apparatus of claim 4, wherein the selection of the first direction is based on the strength of each of the interference signals.

6. The apparatus of claim 4, wherein the selection of the first direction is based on comparing the strength of each of the interference signals to a predetermined threshold.

7. The apparatus of claim 1, wherein the processing circuitry monitors the multiple directions for a predetermined time period prior to an idle phase of a CCA procedure of the LBT procedure.

8. The apparatus of claim 1, wherein the processing circuitry monitors the multiple directions during an idle phase of a CCA procedure of the LBT procedure.

9. The apparatus of claim 1, wherein the processing circuitry continuously monitors the multiple directions for the interference signals.

10. The apparatus of claim 9, wherein the processing circuitry is further configured to:
preempt an ongoing operation to initiate the directional LBT procedure in the first direction based on the continuous monitoring of the multiple directions.

11. The apparatus of claim 9, wherein an idle phase of a CCA procedure of the LBT procedure is skipped when the processing circuitry continuously monitors the multiple directions for the interference signals.

12. An apparatus comprising processing circuitry configured to:
monitor, using analog beamforming, for interference signals originating from a first direction;
determine, based on the monitoring in the first direction, whether interference signals are originating from a second direction; and
perform a directional listen-before-talk (LBT) procedure comprising a directional clear channel access (CCA) procedure in the second direction based on whether there are interference signals originating from the second direction.

13. The apparatus of claim 12, wherein the processing circuitry determines whether there are interference signals originating from the second direction based on comparing a strength of interference signals from the first direction to a predetermined threshold.

14. The apparatus of claim 13, wherein, when the strength of interference signals from the first direction is below the predetermined threshold, an idle phase of the CCA procedure is skipped.

15. The apparatus of claim 13, wherein, when the strength of interference signals from the first direction is above the predetermined threshold, an idle phase of the CCA procedure is performed.

16. An apparatus comprising processing circuitry configured to:
initiate a first directional listen-before-talk (LBT) procedure comprising a directional clear channel access (CCA) procedure in a first direction; and
during the first LBT procedure, initiate a second LBT procedure comprising a directional CCA procedure in a second direction.

17. The apparatus of claim 16, wherein the second LBT procedure is initiated during a deferral period of the first CCA procedure.

18. The apparatus of claim 16, wherein the second LBT procedure is aborted when the directional CCA procedure of the first LBT procedure is successful.

19. The apparatus of claim 16, wherein the second LBT procedure is performed to completion when the directional CCA procedure of the first LBT procedure is unsuccessful.
